(19) United States
(12) Patent Application Publication
(10) Pub. No.: US 2002/0026253 A1
(43) Pub. Date: Feb. 28, 2002

(54) Speech processing apparatus

(76) Inventor: Jebu Jacob Rajan, Berkshire (GB)

Correspondence Address: FITZPATRICK CELLA HARPER & SCINTO, 30 ROCKEFELLER PLAZA, NEW YORK, NY, 10112, US

(21) Appl. No.: 09/866,585

(22) Filed: May 30, 2001

(30) Foreign Application Priority Data
Jun. 2, 2000 (GB) GB 0013541.8
Aug. 17, 2000 (GB) GB 0020310.9

(51) Int. Cl. G06F 17/00; H04R 5/00

(52) U.S. Cl. 700/94; 381/23

(57) ABSTRACT

An audio transmission system is provided which is operable to receive sets of signals representative of a speech signal generated by a speech source. The system is operable to determine parameters representative of each of the sets of signal values, to encode these parameter values and then to transmit these parameter values to a receiver circuit. At the receiver, the encoded parameters are decoded to recover the parameter values. The recovered parameter values may then be used to resynthesise the speech using a speech synthesiser or they may be used by a speech recognition system to generate a recognition result.

The present invention relates to an apparatus for and method of audio encoding. The invention particularly relates to a statistical processing of an input speech signal to derive parameter values defining the speech production system which generated the speech and the subsequent transmission of those parameter values.

A number of speech transmission systems have been proposed. These can be categorised into systems which transmit essentially the speech signals and those which parameterise the speech first (based on some speech model) and transmit the parameters. The problem with the first technique is that it requires a relatively large bandwidth to transmit the speech signals compared with parameterising the speech signals first and then transmitting the parameters. However, parameterising the speech results in more complex transmitter circuitry in order to determine the parameter values and more complex receiver circuitry in order to regenerate the speech from the transmitted parameters. Further, the second technique also reduces the quality of the regenerated speech at the receiver, since some speech information will inevitably be lost through the parameterisation.

Many different techniques are known to parameterise speech signals. One of the most commonly used techniques is based on a linear prediction analysis of the speech. With this technique, the entire speech signal is divided into a number of time frames (typically having a duration of 10 to 30 ms) and a set of linear prediction parameters (or coefficients) is calculated to represent the speech within each time frame. This linear prediction analysis assumes that the value of a current speech sample can be predicted from a linear weighted combination of the k most recent speech samples. Based on this model, the task of the linear prediction analyses is to identify the value of the weightings (or coefficients) which minimises the mean squared error between the actual value of the current speech sample and the predicted value of the current speech sample.

One of the problems with this linear prediction analysis is that is analyses the speech within each frame in isolation from the speech within other frames. It also assumes that the same number of weightings or coefficients represent the speech within each time frame. As a result, errors are introduced into the representation.

An aim of the present invention is to provide an alternative technique for parameterising speech prior to transmission from a transmitting terminal to a receiving terminal.

According to one aspect, the present invention provides an audio encoding system comprising: a memory for storing a probability density function for parameters of a predetermined audio model which is assumed to have generated a set of received audio signal values; means for applying the set of received audio signal values to the probability density function; means for processing said function with the set of received audio signal values applied to determine samples of parameter values from said probability density function; means for analysing at least some of the determined samples to determine parameter values that are representative of the received audio signal values; and means for encoding said determined parameter values to generate encoded data representative of the received audio signal values.

Exemplary embodiments of the present invention will now be described with reference to the accompanying drawings in which:

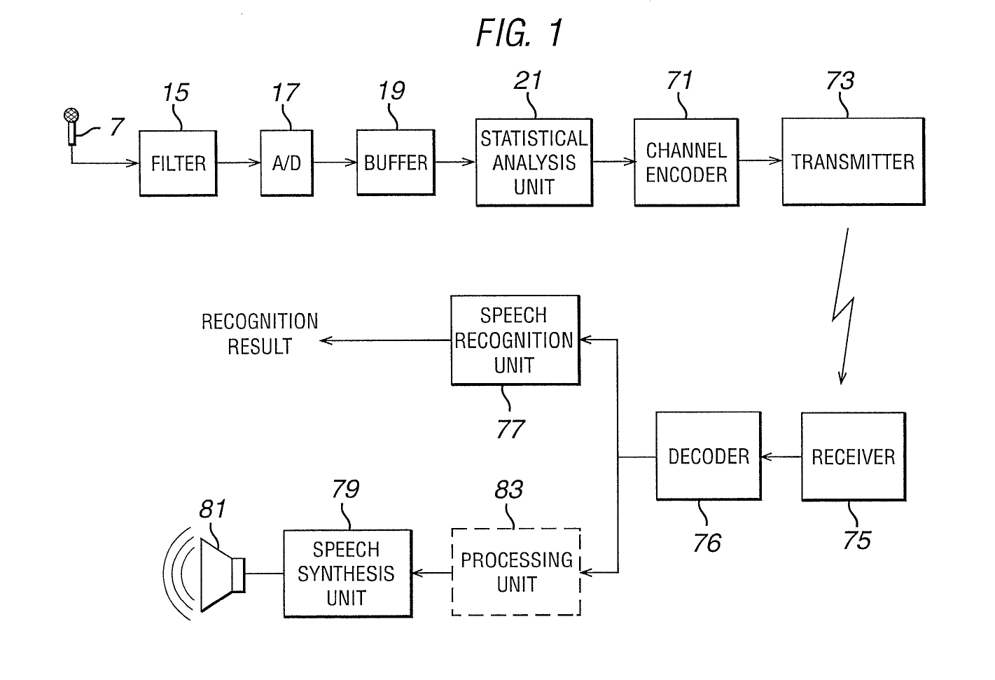

FIG. 1 is a schematic block diagram illustrating the principal components of a speech encoding and transmission system;

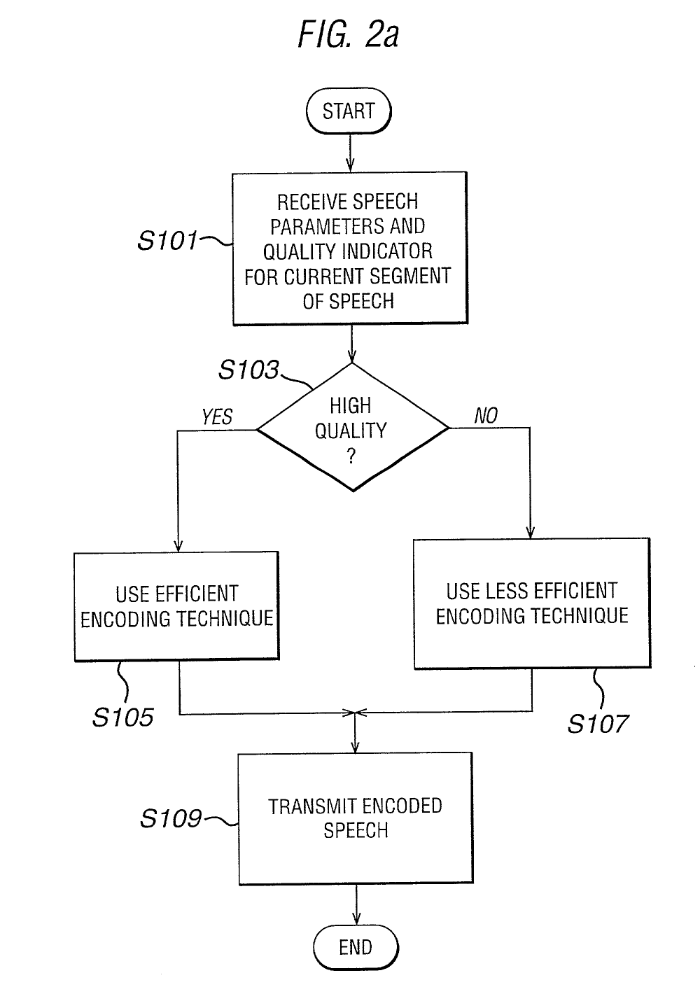

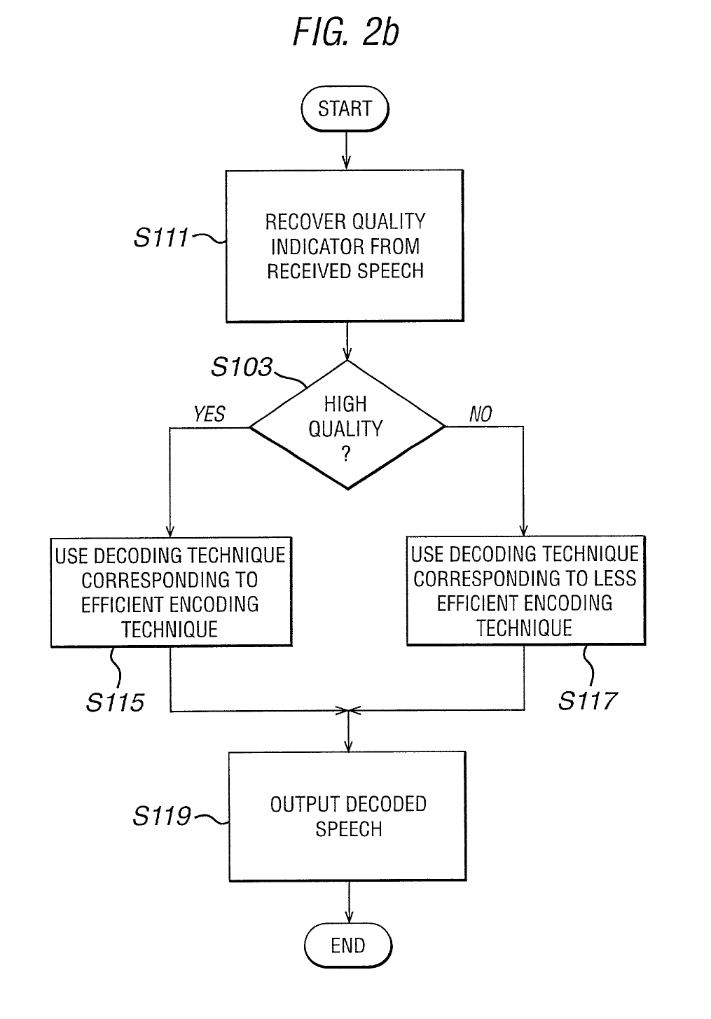

FIG. 2a is a flow chart illustrating the processing steps performed by the transmission side of the system shown in FIG. 1;

FIG. 2b is a flow chart illustrating the processing steps performed by the receiving side of the system shown in FIG. 1;

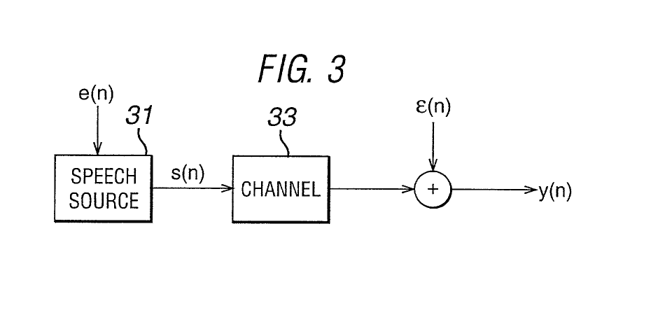

FIG. 3 is a block diagram representing a model employed by a statistical analysis unit which forms part of the speech transmission system shown in FIG. 1;

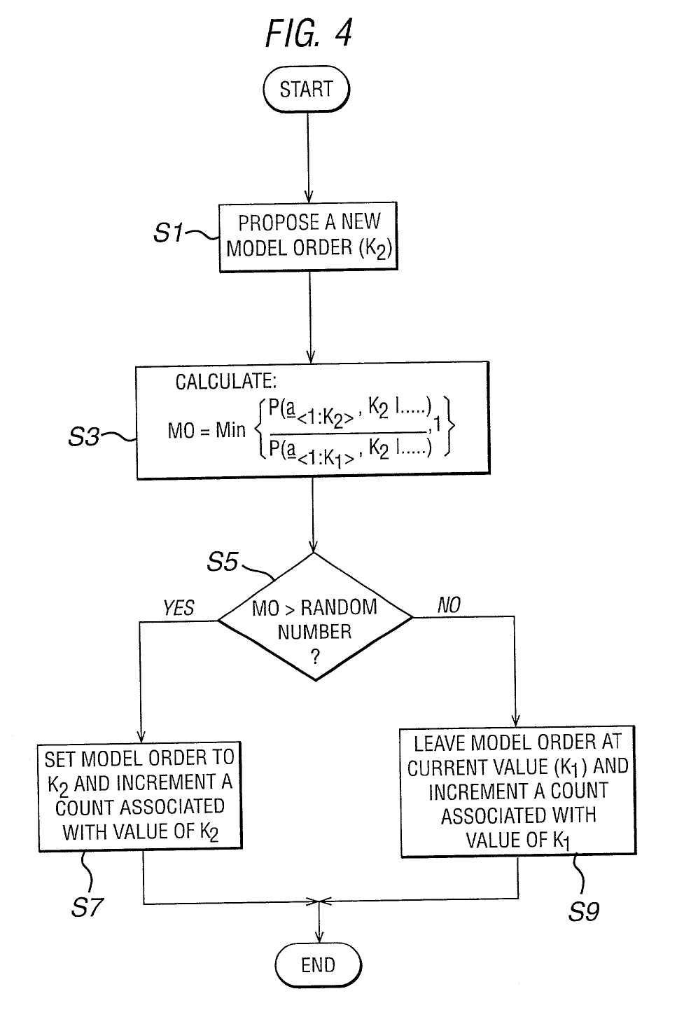

FIG. 4 is a flow chart illustrating the processing steps performed by a model order selection unit forming part of the statistical analysis unit shown in FIG. 1;

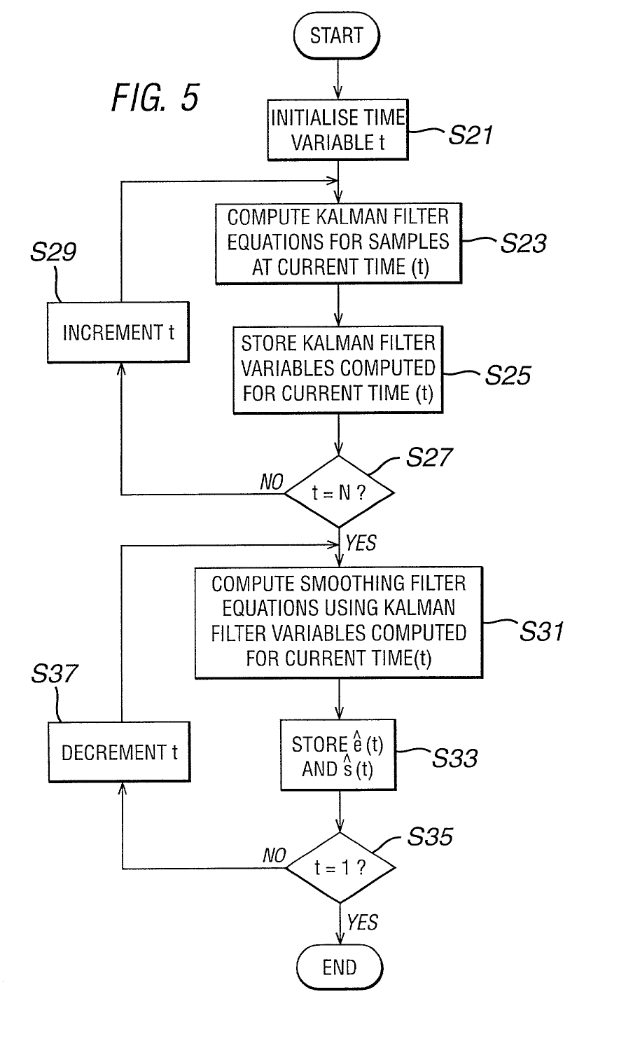

FIG. 5 is a flow chart illustrating the main processing steps employed by a Simulation Smoother which forms part of the statistical analysis unit shown in FIG. 1;

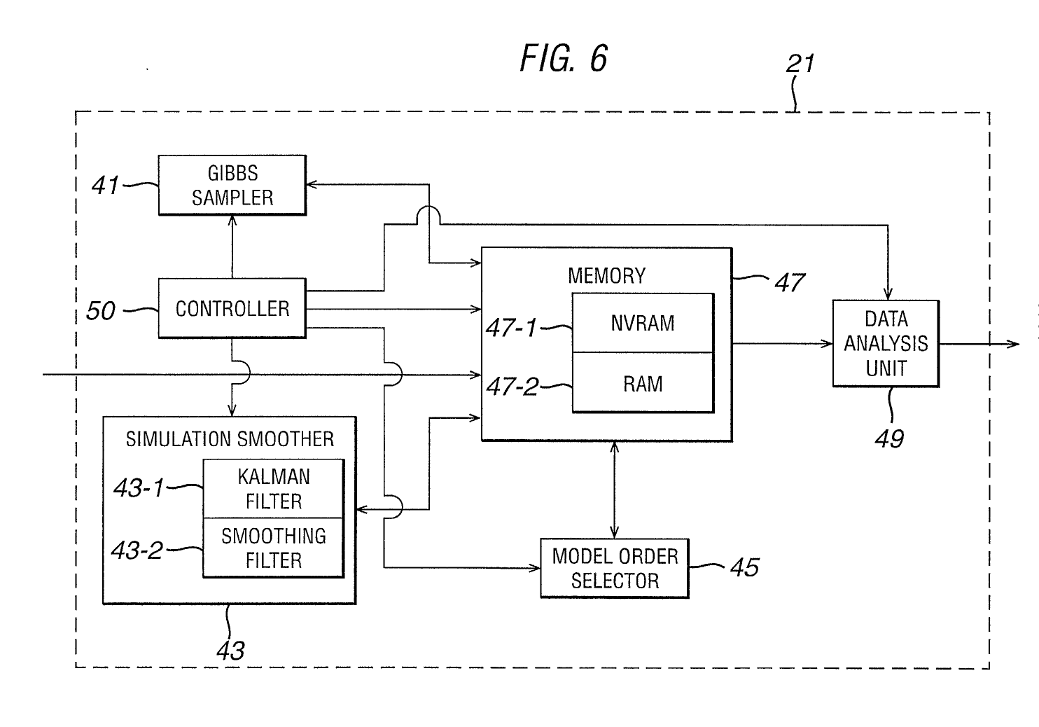

FIG. 6 is a block diagram illustrating the main processing components of the statistical analysis unit shown in FIG. 1;

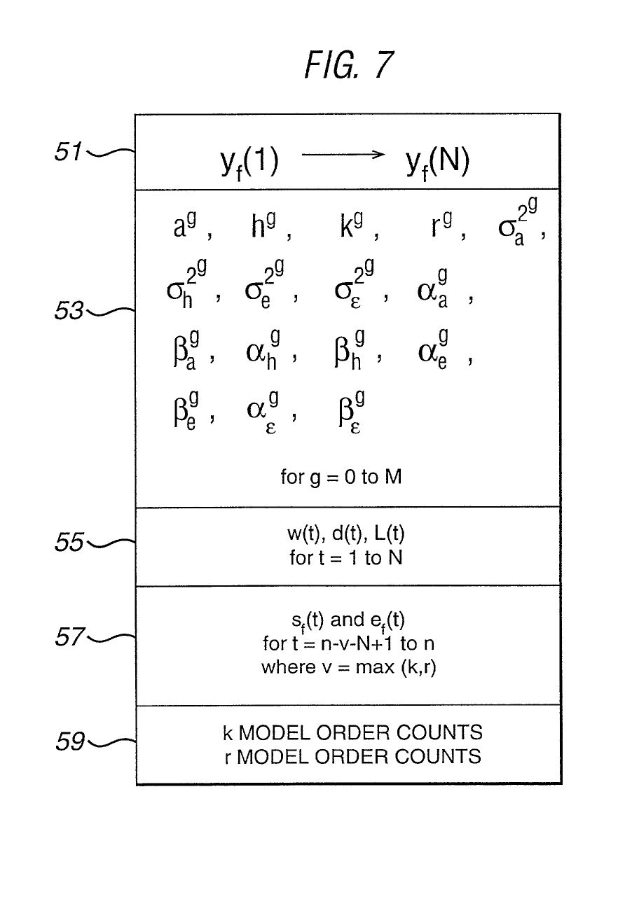

FIG. 7 is a memory map illustrating the data that is stored in a memory which forms part of the statistical analysis unit shown in FIG. 1;

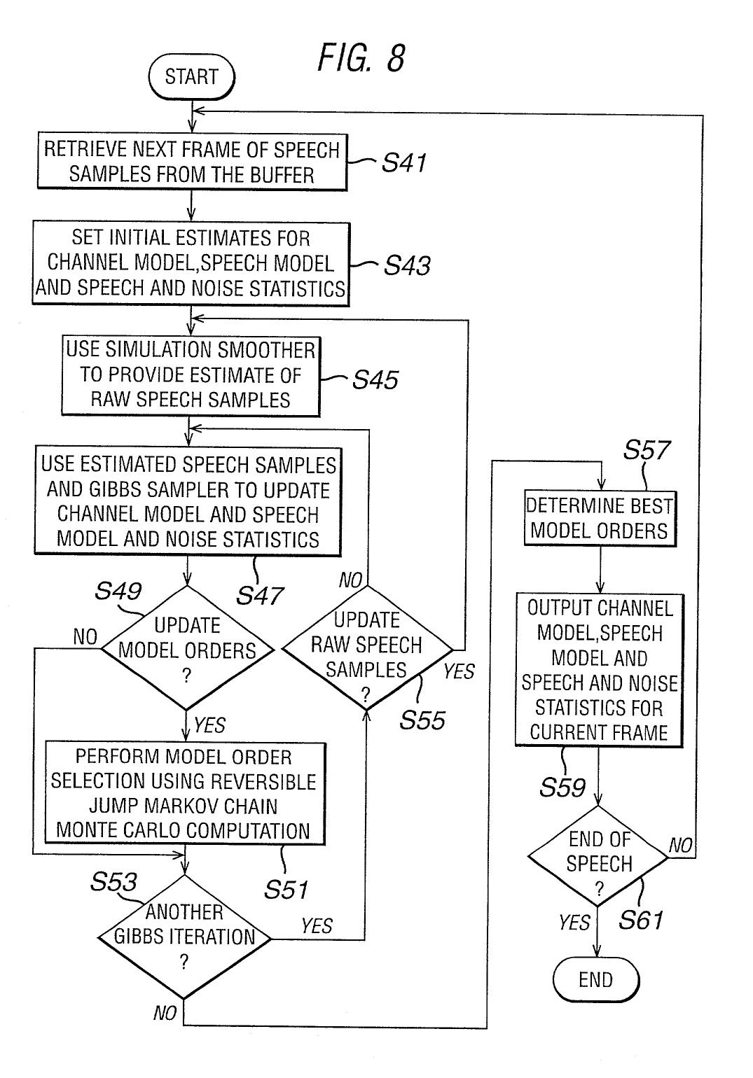

FIG. 8 is a flow chart illustrating the main processing steps performed by the statistical analysis unit shown in FIG. 6;

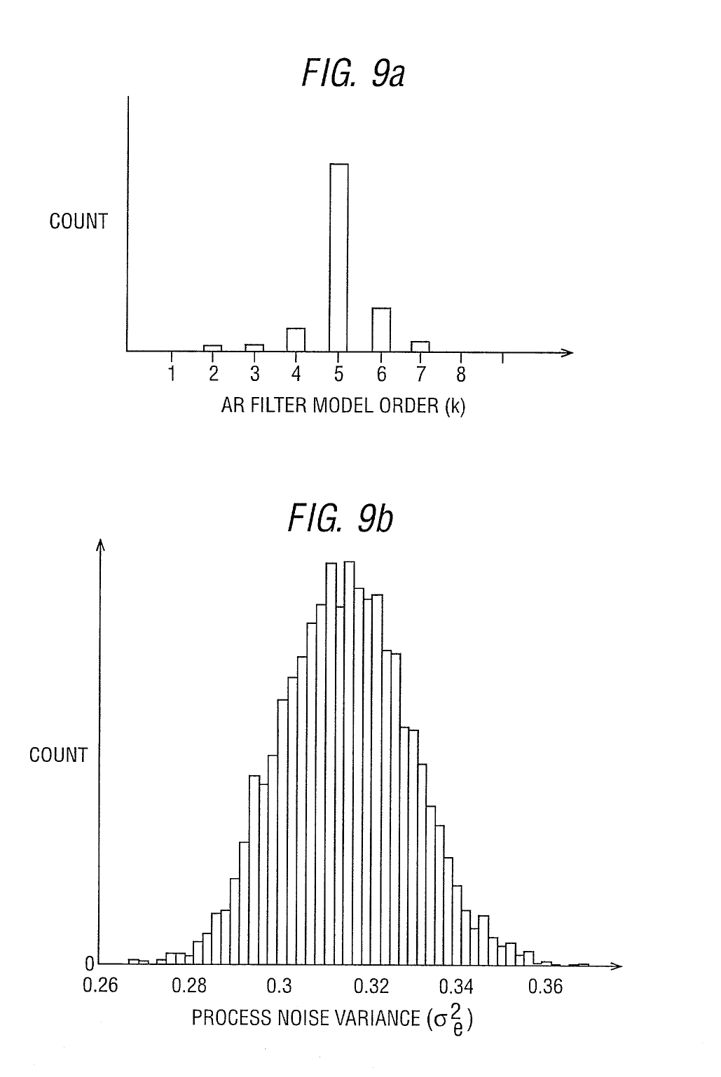

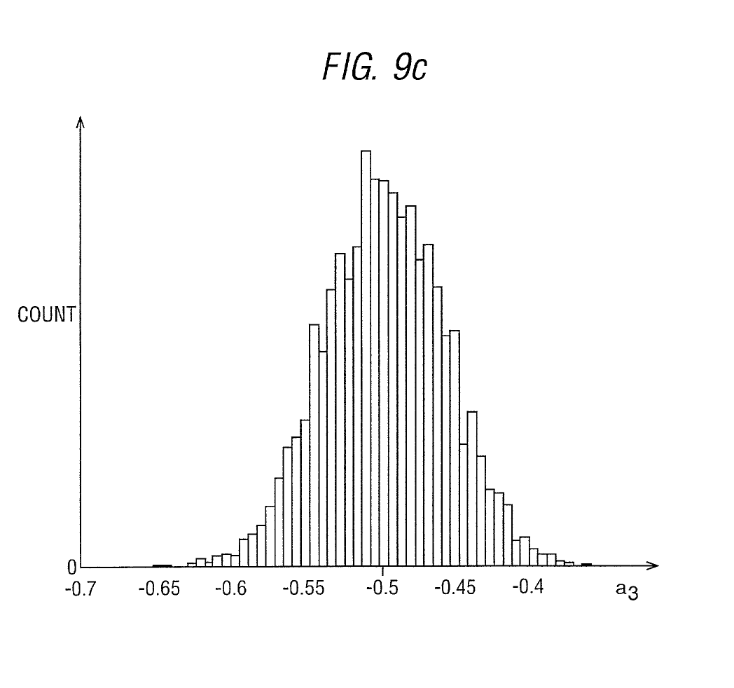

FIG. 9a is a histogram for a model order of an auto regressive filter model which forms part of the model shown in FIG. 3;

FIG. 9b is a histogram for the variance of process noise modelled by the model shown in FIG. 3; and

FIG. 9c is a histogram for a third coefficient of the AR filter model.

Embodiments of the present invention can be implemented in computer hardware, computer software or a mix of computer hardware and software. When implemented using computer software, the program instructions that make the programmable hardware operate in accordance with the present invention may be supplied on, for example, a storage device such as a magnetic disc or by downloading the software from a computer device over a computer network.

FIG. 1 shows a speech encoding and transmission system. Electrical signals representative of input speech from the microphone 7 are input to a filter 15 which removes unwanted frequencies (in this embodiment frequencies above 8 kHz). The filtered signal is then sampled (at a rate of 16 kHz) and digitized by an analogue to digital converter 17 and the digitized speech samples are then stored in a buffer 19. Sequential blocks (or frames) of speech samples are then passed from the buffer 19 to a statistical analyses unit 21 which performs a statistical analysis of each frame of speech samples in sequence to determine, amongst other things, a set of auto regressive (AR) coefficients representative of the speech within the frame. In this embodiment, the AR coefficients output by the statistical analysis unit 21 are input to a channel encoder which encodes the sequences of AR filter coefficients so that they are in a more suitable form for transmission through a communications channel. The encoded AR filter coefficients are then passed to a transmitter 73 where the encoded data is used to modulate a carrier signal which is then transmitted to a remote receiver 75. The receiver 75 demodulates the received signal to recover the encoded data which is then decoded by a decoder 76. The sequence of AR coefficients output by the decoder are then either passed to a speech recognition unit 77 which compares the sequences with stored reference models (not shown) to generate a recognition result or to a speech synthesis unit 79 which regenerates the speech and outputs it via a loudspeaker 81. As shown, prior to application to the speech synthesis unit 79, the sequences of AR coefficients may also pass through an optional processing unit 83 (shown in phantom) which can be used to manipulate the characteristics of the speech that is synthesised.

FIG. 2a is a flow chart illustrating the processing steps performed by the channel encoder 71 of the system shown in FIG. 1. As shown, in step S101 the channel encoder 71 receives the speech parameters and the quality indicator for the current segment of speech to be transmitted. The processing then proceeds to step S103 where the channel encoder 71 determines whether or not the speech parameters to be transmitted were generated from a high quality speech signal. If they are, then the processing proceeds to step S105 where the channel encoder 71 encodes the speech parameters using an efficient encoding technique which minimises the data to be transmitted. If, on the other hand, step S103 determines that the speech parameters were derived from low quality speech, then the processing proceeds to step S107 where the channel encoder 71 uses a less efficient encoding technique (or no encoding) which minimises information lost in the encoding. After step S105 or S107, the processing proceeds to step S109 where the channel encoder 71 outputs the data to be transmitted to the transmitter unit 73 which transmits the encoded speech to the receiver 75. In this embodiment, the channel encoder 71 also encodes and transmits the quality indicator to the receiver 75 so that the receiver can decode the encoded speech parameters using the appropriate decoding technique. In order that the receiver can always decode the encoded speech quality indicator, the channel encoder 71 encodes this information using a standard encoding technique regardless of what the quality indicator is.

FIG. 2b is a flow chart illustrating the processing steps performed by the decoder 76 shown in FIG. 1. As shown, in step S111, the decoder 76 recovers the quality indicator from the received encoded speech data. The processing then proceeds to step S113 where the decoder 76 determines whether or not the received encoded speech parameters where generated from a high quality speech signal. If they were, then the processing proceeds to step S115 where the decoder uses a decoding technique corresponding to the efficient encoding technique used in step S105. If, on the other hand, the decoder 76 determines that the received encoded speech data was generated from a low quality speech signal, then the processing proceeds to step S117 where the decoder 76 decodes the received data using a decoding technique corresponding to the less efficient encoding technique used in step S107. The processing then proceeds to step S119 where the decoded speech parameters are output either to the speech recognition unit 77 or to the speech synthesis unit 79.

Statistical Analysis Unit—Theory and Overview

As mentioned above, the statistical analysis unit 21 analyses the speech within successive frames of the input speech signal. In most speech processing systems, the frames are overlapping. However, in this embodiment, the frames of speech are non-overlapping and have a duration of 20 ms which, with the 16 kHz sampling rate of the analogue to digital converter 17, results in a frame size of 320 samples.

In order to perform the statistical analysis on each of the frames, the analysis unit 21 assumes that there is an underlying process which generated each sample within the frame. The model of this process used in this embodiment is shown in FIG. 2. As shown, the process is modelled by a speech source 31 which generates, at time t=n, a raw speech sample s(n). Since there are physical constraints on the movement of the speech articulators, there is some correlation between neighbouring speech samples. Therefore, in this embodiment, the speech source 31 is modelled by an auto regressive (AR) process. In other words, the statistical analysis unit 21 assumes that a current raw speech sample (s(n)) can be determined from a linear weighted combination of the most recent previous raw speech samples, i.e.:

s(n)=a₁s(n−1)+a₂s(n−2)+ . . . +aₖs(n−k)+e(n) (1)

where a₁, a₂ . . . aₖ are the AR filter coefficients representing the amount of correlation between the speech samples; k is the AR filter model order; and e(n) represents random process noise which is involved in the generation of the raw speech samples. As those skilled in the art of speech processing will appreciate, these AR filter coefficients are the same coefficients that the linear prediction analysis estimates albeit using a different processing technique.

As shown in FIG. 3, the raw speech samples s(n) generated by the speech source are input to a channel 33 which models the acoustic environment between the speech source 31 and the output of the analogue to digital converter 17. Ideally, the channel 33 should simply attenuate the speech as it travels from the source 31 to the microphone. However, due to reverberation and other distortive effects, the signal (y(n)) output by the analogue to digital converter 17 will depend not only on the current raw speech sample (s(n)) but it will also depend upon previous raw speech samples. Therefore, in this embodiment, the statistical analysis unit 21 models the channel 33 by a moving average (MA) filter, i.e.:

y(n)=h₀s(n)+h₁s(n−1)+h₂s(n−2)+ . . . +hᵣs(n−r)+ε(n) (2)

where y(n) represents the signal sample output by the analogue to digital converter 17 at time t=n; h₀, h₁, h₂ . . . hᵣ are the channel filter coefficients representing the amount of distortion within the channel 33; r is the channel filter model order; and ε(n) represents a random additive measurement noise component.

For the current frame of speech being processed, the filter coefficients for both the speech source and the channel are assumed to be constant but unknown. Therefore, considering all N samples (where N=320) in the current frame being processed gives:

s(n)=a₁s(n−1)+a₂s(n−2)+. . . +aₖs(n−k)+e(n)

s(n−1)=a₁s(n−2)+a₂s(n−3)+. . . +aₖs(n−k−1)+e(n−1)

s(n−N+1)=a₁s(n−N)+a₂s(n−N−1)+. . . +aₖs(n−k−N+1)+e(n−N+1) (3)

which can be written in vector form as:

s(n)=S·a+e(n) (4)

where

$$S = {[ \begin{matrix}s ( n - 1 ) & s ( n - 2 ) & s ( n - 3 ) & ⋯ & s ( n - k ) \\ s ( n - 2 ) & s ( n - 3 ) & s ( n - 4 ) & ⋯ & s ( n - k - 1 ) \\ s ( n - 3 ) & s ( n - 4 ) & s ( n - 5 ) & ⋯ & s ( n - k - 2 ) \\ ⋮ & & & ⋰ & \\ s ( n - N ) & s ( n - N - 1 ) & s ( n - N - 2 ) & ⋯ & s ( n - k - N + 1 )\end{matrix} ]}_{Nxk}$$

$$and$$

$$\underline{a} = {[ \begin{matrix}{a}_{1} \\ {a}_{2} \\ {a}_{3} \\ ⋮ \\ {a}_{k}\end{matrix} ]}_{kx1} \underline{s} ( n ) = {[ \begin{matrix}s ( n ) \\ s ( n - 1 ) \\ s ( n - 2 ) \\ ⋮ \\ s ( n - N + 1 )\end{matrix} ]}_{Nx1} \underline{e} ( n ) = {[ \begin{matrix}e ( n ) \\ e ( n - 1 ) \\ e ( n - 2 ) \\ ⋮ \\ e ( n - N + 1 )\end{matrix} ]}_{Nx1}$$

As will be apparent from the following discussion, it is also convenient to rewrite equation (3) in terms of the random error component (often referred to as the residual) e(n). This gives:

e(n)=s(n)−a₁s(n−1)−a₂s(n−2)−. . . −aₖs(n−k)

e(n−1)=s(n−1)−a₁s(n−2)−a₂s(n−3)−. . . −aₖs(n−k−1) (5)

which can be written in vector notation as:

e(n)=Äs(n) (6)

where

$$\overline{A} = {[ \begin{matrix}1 & - {a}_{1} & - {a}_{2} & - {a}_{3} & ⋯ & - {a}_{k} & 0 & 0 & 0 & ⋯ & 0 \\ 0 & 1 & - {a}_{1} & - {a}_{2} & ⋯ & - {a}_{k - 1} & - {a}_{k} & 0 & 0 & ⋯ & 0 \\ 0 & 0 & 1 & - {a}_{1} & ⋯ & - {a}_{k - 2} & - {a}_{k - 1} & - {a}_{k} & 0 & ⋯ & 0 \\ ⋮ & & & & ⋰ & & & & & & \\ 0 & & & & & & & & & & 1\end{matrix} ]}_{NxN}$$

Similarly, considering the channel model defined by equation (2), with h₀=1 (since this provides a more stable solution), gives:

q(n)=h₁s(n−1)+h₂s(n−2)+. . . +hᵣs(n−r)+ε(n)

q(n−1)=h₁s(n−2)+h₂s(n−3)+. . . +hᵣs(n−r−1)+ε(n−1)

q(n−N+1)=h₁s(n−N)+h₂s(n−N−1)+. . . +hᵣs(n−r−N+1)+ε(n−N+1) (7)

(where q(n)=y(n)−s(n)) which can be written in vector form as:

q(n)=Y·h+ε(n) (8)

where

$$Y = {[ \begin{matrix}s ( n - 1 ) & s ( n - 2 ) & s ( n - 3 ) & ⋯ & s ( n - r ) \\ s ( n - 2 ) & s ( n - 3 ) & s ( n - 4 ) & ⋯ & s ( n - r - 1 ) \\ s ( n - 3 ) & s ( n - 4 ) & s ( n - 5 ) & ⋯ & s ( n - r - 2 ) \\ ⋮ & & & ⋰ & \\ s ( n - N ) & s ( n - N - 1 ) & s ( n - N - 2 ) & ⋯ & s ( n - r - N + 1 )\end{matrix} ]}_{Nxr}$$

$$and$$

$$\underline{h} = {[ \begin{matrix}{h}_{1} \\ {h}_{2} \\ {h}_{3} \\ ⋮ \\ {h}_{r}\end{matrix} ]}_{rx1} \underline{q} ( n ) = {[ \begin{matrix}q ( n ) \\ q ( n - 1 ) \\ q ( n - 2 ) \\ ⋮ \\ q ( n - N + 1 )\end{matrix} ]}_{Nx1} \underline{ϵ} ( n ) = {[ \begin{matrix}ϵ ( n ) \\ ϵ ( n - 1 ) \\ ϵ ( n - 2 ) \\ ⋮ \\ ϵ ( n - N + 1 )\end{matrix} ]}_{Nx1}$$

In this embodiment, the analysis unit 21 aims to determine, amongst other things, values for the AR filter coefficients (a) which best represent the observed signal samples (y(n)) in the current frame. It does this by determining the AR filter coefficients (a) that maximise the joint probability density function of the speech model, channel model, speech samples and the noise statistics given the observed signal samples output from the analogue to digital converter 17, i.e. by determining:

$${max}_{\underline{a} } \{ p ( \underline{a} , k , \underline{h} , r , {σ}_{e}^{2} , {σ}_{ϵ}^{2} , \underline{s} ( n ) \vert \underline{y} ( n ) ) \} \qquad ( 9 )$$

where σₑ² and σ_{ε}² represent the process and measurement noise statistics respectively. As those skilled in the art will appreciate, this function defines the probability that a particular speech model, channel model, raw speech samples and noise statistics generated the observed frame of speech samples (y(n)) from the analogue to digital converter. To do this, the statistical analysis unit 21 must determine what this function looks like. This problem can be simplified by rearranging this probability density function using Bayes law to give:

$$\frac{p ( \underline{y} ( n ) \vert \underline{s} ( n ) , \underline{h} , r , {σ}_{e}^{2} ) p ( \underline{s} ( n ) \vert \underline{a} , k , {σ}_{e}^{2} ) p ( \underline{a} \vert k ) p ( \underline{h} \vert r ) p ( {σ}_{e}^{2} ) p ( {σ}_{e}^{2} ) p ( k ) p ( r )}{p ( \underline{y} ( n ) )} \qquad ( 10 )$$

As those skilled in the art will appreciate, the denominator of equation (10) can be ignored since the probability of the signals from the analogue to digital converter is constant for all choices of model. Therefore, the AR filter coefficients that maximise the function defined by equation (9) will also maximise the numerator of equation (10).

Each of the terms on the numerator of equation (10) will now be considered in turn.

p(s(n)|a, k, σₑ²)

This term represents the joint probability density function for generating the vector of raw speech samples (s(n)) during a frame, given the AR filter coefficients (a), the AR filter model order (k) and the process noise statistics (σₑ²) From equation (6) above, this joint probability density function for the raw speech samples can be determined from the joint probability density function for the process noise. In particular p(s(n)|a, k, σₑ²) is given by:

$$p ( \underline{s} ( n ) \vert \underline{a} , k , {σ}_{e}^{2} ) = p ( \underline{e} ( n ) ) {\vert \frac{δ \underline{e} ( n )}{δ \underline{s} ( n )} \vert}_{\underline{e} ( n ) = \underline{s} ( n ) - S \underline{a}} \qquad ( 11 )$$

where p(e(n)) is the joint probability density function for the process noise during a frame of the input speech and the second term on the right-hand side is known as the Jacobean of the transformation. In this case, the Jacobean is unity because of the triangular form of the matrix Ä (see equations (6) above).

In this embodiment, the statistical analysis unit 21 assumes that the process noise associated with the speech source 31 is Gaussian having zero mean and some unknown variance σₑ². The statistical analysis unit 21 also assumes that the process noise at one time point is independent of the process noise at another time point. Therefore, the joint probability density function for the process noise during a frame of the input speech (which defines the probability of any given vector of process noise e(n) occurring) is given by:

$$p ( \underline{e} ( n ) ) = {( 2 π {σ}_{e}^{2} )}^{- \frac{N}{2}} exp [ \frac{- {\underline{e} ( n )}^{T} \underline{e} ( n )}{2 {σ}_{e}^{2}} ] \qquad ( 12 )$$

Therefore, the joint probability density function for a vector of raw speech samples given the AR filter coefficients (a), the AR filter model order (k) and the process noise variance (σₑ²) is given by:

$$p ( \underline{s} ( n ) \vert \underline{a} , k , {σ}_{e}^{2} ) = {( 2 π {σ}_{e}^{2} )}^{- \frac{N}{2}} exp [ \frac{- 1}{2 {σ}_{e}^{2}} ( {\underline{s} ( n )}^{T} \underline{s} ( n ) - 2 {\underline{a}}^{T} S \underline{s} ( n ) + {\underline{a}}^{T} {S}^{T} S \underline{a} ) ] \qquad ( 13 )$$

p(y(n)|s(n), h, r, σ_{ε}²)

This term represents the joint probability density function for generating the vector of speech samples (y(n)) output from the analogue to digital converter 17, given the vector of raw speech samples (s(n)), the channel filter coefficients (h), the channel filter model order (r) and the measurement noise statistics (σ_{ε}²) From equation (8), this joint probability density function can be determined from the joint probability density function for the process noise. In particular, p(y(n)|s(n), h, r, σ_{ε}²) is given by:

$$p ( \underline{y} ( n ) \vert \underline{s} ( n ) , \underline{h} , r , {σ}_{ϵ}^{2} ) = p ( \underline{ϵ} ( n ) ) {\vert \frac{δ \underline{ϵ} ( n )}{δ \underline{y} ( n )} \vert}_{\underline{ϵ} ( n ) = \underline{q} ( n ) - Y \underline{h}} \qquad ( 14 )$$

where p(ε(n)) is the joint probability density function for the measurement noise during a frame of the input speech and the second term on the right hand side is the Jacobean of the transformation which again has a value of one.

In this embodiment, the statistical analysis unit 21 assumes that the measurement noise is Gaussian having zero mean and some unknown variance σ_{ε}². It also assumes that the measurement noise at one time point is independent of the measurement noise at another time point. Therefore, the joint probability density function for the measurement noise in a frame of the input speech will have the same form as the process noise defined in equation (12). Therefore, the joint probability density function for a vector of speech samples (y(n)) output from the analogue to digital converter 17, given the channel filter coefficients (h), the channel filter model order (r), the measurement noise statistics (σ_{ε}²) and the raw speech samples (s(n)) will have the following form:

$$p ( \underline{y} ( n ) \vert \underline{s} ( n ) , \underline{h} , r , {σ}_{ϵ}^{2} ) = {( 2 π {σ}_{ϵ}^{2} )}^{- \frac{N}{2}} exp [ \frac{- 1}{2 {σ}_{ϵ}^{2}} ( {\underline{q} ( n )}^{T} \underline{q} ( n ) - 2 {\underline{h}}^{T} Y \underline{q} ( n ) + {\underline{h}}^{T} {Y}^{T} Y \underline{h} ) ] \qquad ( 15 )$$

As those skilled in the art will appreciate, although this joint probability density function for the vector of speech samples (y(n)) is in terms of the variable q(n), this does not matter since q(n) is a function of y(n) and s(n), and s(n) is a given variable (ie known) for this probability density function.

p(a|k)

This term defines the prior probability density function for the AR filter coefficients (a) and it allows the statistical analysis unit 21 to introduce knowledge about what values it expects these coefficients will take. In this embodiment, the statistical analysis unit 21 models this prior probability density function by a Gaussian having an unknown variance (σₐ²) and mean vector (μₐ), i.e.:

$$p ( \underline{a} \vert k , {σ}_{a}^{2} , {\underline{μ}}_{a} ) = {( 2 π {σ}_{a}^{2} )}^{- \frac{N}{2}} exp [ \frac{- {( \underline{a} - {\underline{μ}}_{a} )}^{T} ( \underline{a} - {\underline{μ}}_{a} )}{2 {σ}_{a}^{2}} ] \qquad ( 16 )$$

By introducing the new variables σₐ² and μₐ, the prior density functions (p(σₐ²) and p(μₐ)) for these variables must be added to the numerator of equation (10) above. Initially, for the first frame of speech being processed the mean vector (μₐ) can be set to zero and for the second and subsequent frames of speech being processed, it can be set to the mean vector obtained during the processing of the previous frame. In this case, p(μₐ) is just a Dirac delta function located at the current value of μₐ and can therefore be ignored.

With regard to the prior probability density function for the variance of the AR filter coefficients, the statistical analysis unit 21 could set this equal to some constant to imply that all variances are equally probable. However, this term can be used to introduce knowledge about what the variance of the AR filter coefficients is expected to be. In this embodiment, since variances are always positive, the statistical analysis unit 21 models this variance prior probability density function by an Inverse Gamma function having parameters αₐ and βₐ, i.e.:

$$p ( {σ}_{a}^{2} \vert {α}_{a} , {β}_{a} ) = \frac{{( {σ}_{a}^{2} )}^{- ( {α}_{a} + 1 )}}{{β}_{a} Γ ( {α}_{a} )} exp [ \frac{- 1}{{σ}_{a}^{2} {β}_{a}} ] \qquad ( 17 )$$

At the beginning of the speech being processed, the statistical analysis unit 21 will not have much knowledge about the variance of the AR filter coefficients. Therefore, initially, the statistical analysis unit 21 sets the variance σₐ² and the α and β parameters of the Inverse Gamma function to ensure that this probability density function is fairly flat and therefore non-informative. However, after the first frame of speech has been processed, these parameters can be set more accurately during the processing of the next frame of speech by using the parameter values calculated during the processing of the previous frame of speech.

p(h|r)

This term represents the prior probability density function for the channel model coefficients (h) and it allows the statistical analysis unit 21 to introduce knowledge about what values it expects these coefficients to take. As with the prior probability density function for the AR filter coefficients, in this embodiment, this probability density function is modelled by a Gaussian having an unknown variance (σₕ²) and mean vector (μₕ) i.e.:

$$p ( \underline{h} \vert r , {σ}_{h}^{2} , {\underline{μ}}_{h} ) = {( 2 π {σ}_{h}^{2} )}^{- \frac{N}{2}} exp [ \frac{- {( \underline{h} - {\underline{μ}}_{h} )}^{T} ( \underline{h} - {\underline{μ}}_{h} )}{2 {σ}_{h}^{2}} ] \qquad ( 18 )$$

Again, by introducing these new variables, the prior density functions (p(σₕ) and p(μₕ)) must be added to the numerator of equation (10). Again, the mean vector can initially be set to zero and after the first frame of speech has been processed and for all subsequent frames of speech being processed, the mean vector can be set to equal the mean vector obtained during the processing of the previous frame. Therefore, p(μₕ) is also just a Dirac delta function located at the current value of μₕ and can be ignored.

With regard to the prior probability density function for the variance of the channel filter coefficients, again, in this embodiment, this is modelled by an Inverse Gamma function having parameters αₕ and βₕ. Again, the variance (σₕ²) and the α and β parameters of the Inverse Gamma function can be chosen initially so that these densities are non-informative so that they will have little effect on the subsequent processing of the initial frame.

p(σₑ²) and p(σ_{ε}²)

These terms are the prior probability density functions for the process and measurement noise variances and again, these allow the statistical analysis unit 21 to introduce knowledge about what values it expects these noise variances will take. As with the other variances, in this embodiment, the statistical analysis unit 21 models these by an Inverse Gamma function having parameters αₑ, βₑ and α_{ε}, β_{ε}respectively. Again, these variances and these Gamma function parameters can be set initially so that they are non-informative and will not appreciably affect the subsequent calculations for the initial frame.

p (k) and p(r)

These terms are the prior probability density functions for the AR filter model order (k) and the channel model order (r) respectively. In this embodiment, these are modelled by a uniform distribution up to some maximum order. In this way, there is no prior bias on the number of coefficients in the models except that they can not exceed these predefined maximums. In this embodiment, the maximum AR filter model order (k) is thirty and the maximum channel model order (r) is one hundred and fifty.

Therefore, inserting the relevant equations into the numerator of equation (10) gives the following joint probability density function which is proportional to p(a,k, h,r,σₐ²,σₕ²,σₑ²,σ_{ε}², s(n)|y(n)):

$${( 2 π {σ}_{ϵ}^{2} )}^{- \frac{N}{2}} exp [ \frac{- 1}{2 {σ}_{ϵ}^{2}} ( {\underline{q} ( n )}^{T} \underline{q} ( n ) - 2 {\underline{h}}^{T} Y \underline{q} ( n ) + {\underline{h}}^{T} {Y}^{T} Y \underline{h} ) ] \times {( 2 {πσ}_{e}^{2} )}^{- \frac{N}{2}} exp [ \frac{- 1}{2 {σ}_{e}^{2}} ( {\underline{s} ( n )}^{T} \underline{s} ( n ) - 2 {\underline{a}}^{T} S \underline{s} ( n ) + {\underline{a}}^{T} {S}^{T} S \underline{a} ) ] \times {( 2 π {σ}_{a}^{2} )}^{- \frac{N}{2}} exp [ \frac{- {( \underline{a} - {\underline{μ}}_{a} )}^{T} ( \underline{a} - {\underline{μ}}_{a} )}{2 {σ}_{a}^{2}} ] \times {( 2 π {σ}_{h}^{2} )}^{- \frac{N}{2}} exp [ \frac{- {( \underline{h} - {\underline{μ}}_{h} )}^{T} ( \underline{h} - {\underline{μ}}_{h} )}{2 {σ}_{h}^{2}} ] \times \frac{{( {σ}_{a}^{2} )}^{- ( {α}_{a} + 1 )}}{{β}_{a} Γ ( {α}_{a} )} exp [ \frac{- 1}{{σ}_{a}^{2} {β}_{a}} ] \times \frac{{( {σ}_{h}^{2} )}^{- ( {α}_{h} + 1 )}}{{β}_{h} Γ ( {α}_{h} )} exp [ \frac{- 1}{{σ}_{h}^{2} {β}_{h}} ] \times \frac{{( {σ}_{e}^{2} )}^{- ( {α}_{e} + 1 )}}{{β}_{e} Γ ( {α}_{e} )} exp [ \frac{- 1}{{σ}_{e}^{2} {β}_{e }} ] \times \frac{{( {σ}_{ϵ}^{2} )}^{- ( {α}_{ϵ} + 1 )}}{{β}_{ϵ} Γ ( {α}_{ϵ} )} exp [ \frac{- 1}{{σ}_{ϵ}^{2} {β}_{ϵ}} ] \qquad ( 19 )$$

Gibbs Sampler

In order to determine the form of this joint probability density function, the statistical analysis unit 21 “draws samples” from it. In this embodiment, since the joint probability density function to be sampled is a complex multivariate function, a Gibbs sampler is used which breaks down the problem into one of drawing samples from probability density functions of smaller dimensionality. In particular, the Gibbs sampler proceeds by drawing random variates from conditional densities as follows:

first iteration

p(ak|h⁰,r⁰,σₑ²^{⁰},σ_{ε}²^{⁰},σₐ²^{⁰},σₕ²^{⁰}, s(n)⁰, y(n))→a¹,k¹

p(h,r|a¹,k¹,σₑ²^{⁰},σ_{ε}²^{⁰},σₐ²^{⁰},σₕ²^{⁰}, s(n)⁰, y(n))→h¹,k¹

p(σₑ²|a¹,k¹, h¹,r¹,σ_{ε}²^{⁰},σₐ²^{⁰},σₕ²^{⁰}, s(n)⁰, y(n))→σₑ²^{¹}

$$p ( {σ}_{h}^{{2}^{1}} \vert {\underline{α}}^{1} , {k}^{1} , {\underline{h}}^{1} , {r}^{1} , {σ}_{ϵ}^{{2}^{1}} , {σ}_{a}^{{2}^{1}} , {σ}_{h}^{{2}^{1}} , {\underline{s} ( n )}^{0} , \underline{y} ( n ) ) \to {σ}_{h}^{{2}^{1}}$$

second iteration

p(a,k|h¹,r¹,σₑ²^{¹},σ_{ε}²^{¹},σₕ²^{¹}, s(n)¹, y(n))→a²,k²

p(h,r|a²,k²,σₑ²^{¹},σ_{ε}²^{¹},σₐ²^{¹},σₕ²^{¹},s(n)¹,y(n))→h²,r²

etc.

where (h⁰, r⁰, (σₑ²)⁰, (σ_{ε}²)⁰, (σₐ²)⁰, (σₕ²)⁰, s(n)⁰) are initial values which may be obtained from the results of the statistical analysis of the previous frame of speech, or where there are no previous frames, can be set to appropriate values that will be known to those skilled in the art of speech processing.

As those skilled in the art will appreciate, these conditional densities are obtained by inserting the current values for the given (or known) variables into the terms of the density function of equation (19). For the conditional density p(a,k| . . . ) this results in:

$$p ( \underline{a} , k \vert … ) ∝ exp [ \frac{- 1}{2 {σ}_{e}^{2}} ( {\underline{s} ( n )}^{T} \underline{s} ( n ) - 2 {\underline{a}}^{T} S \underline{s} ( n ) + {\underline{a}}^{T} {S}^{T} S \underline{a} ) ] \times exp [ \frac{- {( \underline{a} - {\underline{μ}}_{a} )}^{T} ( \underline{a} - {\underline{μ}}_{a} )}{2 {σ}_{a}^{2}} ] \qquad ( 20 )$$

which can be simplified to give:

$$p ( \underline{a} , k \vert … ) ∝ exp [ \frac{- 1}{2} ( \begin{matrix}\frac{{\underline{s} ( n )}^{T} \underline{s} ( n )}{{σ}_{e}^{2}} + \frac{{\underline{μ}}_{a}^{T} {μ}_{a}}{{σ}_{a}^{2}} - 2 {\underline{a}}^{T} [ \frac{S \underline{s} ( n )}{{σ}_{e}^{2}} + \frac{{\underline{μ}}_{a}}{{σ}_{a}^{2}} ] + \\ {\underline{a}}^{T} [ \frac{{S}^{T} S}{{σ}_{e}^{2}} + \frac{I}{{σ}_{a}^{2}} ] \underline{a}\end{matrix} ) ] \qquad ( 21 )$$

which is in the form of a standard Gaussian distribution having the following covariance matrix:

$${\sum }_{\underline{a}} = {[ \frac{{S}^{T} S}{{σ}_{e}^{2}} + \frac{I}{{σ}_{a}^{2}} ]}^{- 1} \qquad ( 22 )$$

The mean value of this Gaussian distribution can be determined by differentiating the exponent of equation (21) with respect to a and determining the value of a which makes the differential of the exponent equal to zero. This yields a mean value of:

$${\hat{\underline{μ}}}_{a} = {[ \frac{{S}^{T} S}{{σ}_{e}^{2}} + \frac{I}{{σ}_{a}^{2}} ]}^{- 1} [ \frac{{S}^{T} \underline{s} ( n )}{{σ}_{e}^{2}} + \frac{{\underline{μ}}_{a}}{{σ}_{a}^{2}} ] \qquad ( 23 )$$

A sample can then be drawn from this standard Gaussian distribution to give ag (where g is the g^{th} iteration of the Gibbs sampler) with the model order (kg) being determined by a model order selection routine which will be described later. The drawing of a sample from this Gaussian distribution may be done by using a random number generator which generates a vector of random values which are uniformly distributed and then using a transformation of random variables using the covariance matrix and the mean value given in equations (22) and (23) to generate the sample. In this embodiment, however, a random number generator is used which generates random numbers from a Gaussian distribution having zero mean and a variance of one. This simplifies the transformation process to one of a simple scaling using the covariance matrix given in equation (22) and shifting using the mean value given in equation (23). Since the techniques for drawing samples from Gaussian distributions are well known in the art of statistical analysis, a further description of them will not be given here. A more detailed description and explanation can be found in the book entitled “Numerical Recipes in C”, by W. Press et al, Cambridge University Press, 1992 and in particular at chapter 7.

As those skilled in the art will appreciate, however, before a sample can be drawn from this Gaussian distribution, estimates of the raw speech samples must be available so that the matrix S and the vector s(n) are known. The way in which these estimates of the raw speech samples are obtained in this embodiment will be described later.

A similar analysis for the conditional density p(h,r| . . . ) reveals that it also is a standard Gaussian distribution but having a covariance matrix and mean value given by:

$${\sum }_{\underline{h}} = {[ \frac{{Y}^{T} Y}{{σ}_{ϵ}^{2}} + \frac{I}{{σ}_{h}^{2}} ]}^{- 1} \\ {\underline{\hat{μ}}}_{h} = {[ \frac{{Y}^{T} Y}{{σ}_{ϵ}^{2}} + \frac{I}{{σ}_{h}^{2}} ]}^{- 1} [ \frac{{Y}^{T} \underline{q} ( n )}{{σ}_{ϵ}^{2}} + \frac{{\underline{μ}}_{h}}{{σ}_{h}^{2}} ] \qquad ( 24 )$$

from which a sample for h^{g} can be drawn in the manner described above, with the channel model order (r^{g}) being determined using the model order selection routine which will be described later.

A similar analysis for the conditional density p(σₑ²| . . . ) shows that:

$$p ( {σ}_{e}^{2} \vert … ) ∝ {( {σ}_{e}^{2} )}^{- \frac{N}{2}} exp [ \frac{- E}{2 {σ}_{e}^{2}} ] \frac{{( {σ}_{e}^{2} )}^{- ( {α}_{e} + 1 )}}{{β}_{e} Γ ( {α}_{e} )} exp [ \frac{- 1}{{σ}_{e}^{2} {β}_{e}} ] \qquad ( 25 )$$

where:

E=s(n)^{T}s(n)−2a^{T}Ss(n)+a^{T}S^{T}Sa

which can be simplified to give:

$$p ( {σ}_{e}^{2} \vert … ) ∝ {( {σ}_{e}^{2} )}^{- [ ( \frac{N}{2} + {α}_{e} ) + 1 ]} exp [ \frac{- 1}{{σ}_{e}^{2}} ( \frac{E}{2} + \frac{1}{{β}_{e}} ) ] \qquad ( 26 )$$

which is also an Inverse Gamma distribution having the following parameters:

$${\hat{α}}_{e} = \frac{N}{2} + {α}_{e} and {\hat{β}}_{e} = \frac{2 {β}_{e}}{2 + {β}_{e} \cdot E} \qquad ( 27 )$$

A sample is then drawn from this Inverse Gamma distribution by firstly generating a random number from a uniform distribution and then performing a transformation of random variables using the alpha and beta parameters given in equation (27), to give (σₑ²)^{g}.

A similar analysis for the conditional density p(σ_{ε}²| . . . ) reveals that it also is an Inverse Gamma distribution having the following parameters:

$${\hat{α}}_{ϵ} = \frac{N}{2} + {α}_{ϵ} and {\hat{β}}_{e} = \frac{2 {β}_{ϵ}}{2 + {β}_{ϵ} \cdot {E}^{*}} \qquad ( 28 )$$

where:

E*=q(n)^{T}q(n)−2h^{T}Yq(n)+h^{T}Y^{T}Yh

A sample is then drawn from this Inverse Gamma distribution in the manner described above to give (σ_{ε}²)^{g}.

A similar analysis for conditional density p(σₐ²| . . . ) reveals that it too is an Inverse Gamma distribution having the following parameters:

$${\hat{α}}_{a} = \frac{N}{2} + {α}_{a} and {\hat{β}}_{a} = \frac{2 {β}_{a}}{2 + {β}_{a} \cdot {( \underline{a} - {\underline{μ}}_{a} )}^{T} ( \underline{a} - {\underline{μ}}_{a} )} \qquad ( 29 )$$

A sample is then drawn from this Inverse Gamma distribution in the manner described above to give (σₐ²)^{g}.

Similarly, the conditional density p(σₕ²| . . . ) is also an Inverse Gamma distribution but having the following parameters:

$${\hat{a}}_{h} = \frac{N}{2} + {α}_{h} and {\hat{β}}_{h} = \frac{2 {β}_{h}}{2 + {β}_{h} \cdot {( \underline{h} - {\underline{μ}}_{h} )}^{T} ( \underline{h} - {\underline{μ}}_{h} )} \qquad ( 30 )$$

A sample is then drawn from this Inverse Gamma distribution in the manner described above to give (σₕ²)^{g}.

As those skilled in the art will appreciate, the Gibbs sampler requires an initial transient period to converge to equilibrium (known as burn-in). Eventually, after L iterations, the sample (a^{L}, k^{L}, h^{L}, r^{L}, (σₑ²)^{L}, (σ_{ε}²)^{L}, (σₐ²)^{L}, (σₕ²)^{L}, s(n)^{L}) is considered to be a sample from the joint probability density function defined in equation (19). In this embodiment, the Gibbs sampler performs approximately one hundred and fifty (150) iterations on each frame of input speech and discards the samples from the first fifty iterations and uses the rest to give a picture (a set of histograms) of what the joint probability density function defined in equation (19) looks like. From these histograms, the set of AR coefficients (a) which best represents the observed speech samples (y(n)) from the analogue to digital converter 17 are determined. The histograms are also used to determine appropriate values for the variances and channel model coefficients (h) which can be used as the initial values for the Gibbs sampler when it processes the next frame of speech.

Model Order Selection

As mentioned above, during the Gibbs iterations, the model order (k) of the AR filter and the model order (r) of the channel filter are updated using a model order selection routine. In this embodiment, this is performed using a technique derived from “Reversible jump Markov chain Monte Carlo computation”, which is described in the paper entitled “Reversible jump Markov chain Monte Carlo Computation and Bayesian model determination” by Peter Green, Biometrika, vol 82, pp 711 to 732, 1995.

FIG. 4 is a flow chart which illustrates the processing steps performed during this model order selection routine for the AR filter model order (k). As shown, in step s1, a new model order (k₂) is proposed. In this embodiment, the new model order will normally be proposed as k₂=k_{1±1}, but occasionally it will be proposed as k₂=k₁±2 and very occasionally as k₂=k₁±3 etc. To achieve this, a sample is drawn from a discretised Laplacian density function centred on the current model order (k₁) and with the variance of this Laplacian density function being chosen a priori in accordance with the degree of sampling of the model order space that is required.

The processing then proceeds to step s3 where a model order variable (MO) is set equal to:

$$MO = max \{ \frac{p ( {\underline{a}}_{< 1 : {k}_{2} >} , {k}_{2} \vert … )}{p ( {\underline{a}}_{< 1 : {k}_{1} >} , {k}_{1} \vert … )} , 1 \} \qquad ( 31 )$$

where the ratio term is the ratio of the conditional probability given in equation (21) evaluated for the current AR filter coefficients (a) drawn by the Gibbs sampler for the current model order (k₁) and for the proposed new model order (k₂). If k₂>k₁, then the matrix S must first be resized and then a new sample must be drawn from the Gaussian distribution having the mean vector and covariance matrix defined by equations (22) and (23) (determined for the resized matrix S), to provide the AR filter coefficients (a_{<1:k2>}) for the new model order (k₂). If k₂<k₁ then all that is required is to delete the last (k₁−k₂) samples of the a vector. If the ratio in equation (31) is greater than one, then this implies that the proposed model order (k₂) is better than the current model order whereas if it is less than one then this implies that the current model order is better than the proposed model order. However, since occasionally this will not be the case, rather than deciding whether or not to accept the proposed model order by comparing the model order variable (MO) with a fixed threshold of one, in this embodiment, the model order variable (MO) is compared, in step s5, with a random number which lies between zero and one. If the model order variable (MO) is greater than this random number, then the processing proceeds to step s7 where the model order is set to the proposed model order (k₂) and a count associated with the value of k₂ is incremented. If, on the other hand, the model order variable (MO) is smaller than the random number, then the processing proceeds to step s9 where the current model order is maintained and a count associated with the value of the current model order (k₁) is incremented. The processing then ends.

This model order selection routine is carried out for both the model order of the AR filter model and for the model order of the channel filter model. This routine may be carried out at each Gibbs iteration. However, this is not essential. Therefore, in this embodiment, this model order updating routine is only carried out every third Gibbs iteration.

Simulation Smoother

As mentioned above, in order to be able to draw samples using the Gibbs sampler, estimates of the raw speech samples are required to generate s(n), S and Y which are used in the Gibbs calculations. These could be obtained from the conditional probability density function p(s(n)| . . . . However, this is not done in this embodiment because of the high dimensionality of S(n). Therefore, in this embodiment, a different technique is used to provide the necessary estimates of the raw speech samples. In particular, in this embodiment, a “Simulation Smoother” is used to provide these estimates. This Simulation Smoother was proposed by Piet de Jong in the paper entitled “The Simulation Smoother for Time Series Models”, Biometrika (1995), vol 82,2, pages 339 to 350. As those skilled in the art will appreciate, the Simulation Smoother is run before the Gibbs Sampler. It is also run again during the Gibbs iterations in order to update the estimates of the raw speech samples. In this embodiment, the Simulation Smoother is run every fourth Gibbs iteration.

In order to run the Simulation Smoother, the model equations defined above in equations (4) and (6) must be written in “state space” format as follows:

\hat{s}(n)=Ã·ŝ(n−1)+ê(n)

y(n)=h^{T}·ŝ(n−1)+ε(n) (32)

where

$$\tilde{A} = {[ \begin{matrix}{a}_{1} & {a}_{2} & {a}_{3} & ⋯ & {a}_{k} & 0 & ⋯ & 0 \\ 1 & 0 & 0 & ⋯ & 0 & 0 & ⋯ & 0 \\ 0 & 1 & 0 & ⋯ & 0 & 0 & ⋯ & 0 \\ ⋮ & & & ⋰ & & & & \\ 0 & & & & & & 1 & 0\end{matrix} ]}_{rxr}$$

$$and$$

$$\hat{\underline{s}} ( n ) = {[ \begin{matrix}\hat{s} ( n ) \\ \hat{s} ( n - 1 ) \\ \hat{s} ( n - 2 ) \\ ⋮ \\ \hat{s} ( n - r + 1 )\end{matrix} ]}_{rx1} \hat{\underline{e}} ( n ) = {[ \begin{matrix}\hat{e} ( n ) \\ 0 \\ 0 \\ ⋮ \\ 0\end{matrix} ]}_{rx1}$$

With this state space representation, the dimensionality of the raw speech vectors (ŝ(n)) and the process noise vectors (ê(n)) do not need to be N×1 but only have to be as large as the greater of the model orders −k and r. Typically, the channel model order (r) will be larger than the AR filter model order (k). Hence, the vector of raw speech samples (ŝ(n)) and the vector of process noise (ê(n)) only need to be r×1 and hence the dimensionality of the matrix Ã only needs to be r×r.

The Simulation Smoother involves two stages—a first stage in which a Kalman filter is run on the speech samples in the current frame and then a second stage in which a “smoothing” filter is run on the speech samples in the current frame using data obtained from the Kalman filter stage. FIG. 5 is a flow chart illustrating the processing steps performed by the Simulation Smoother. As shown, in step s21, the system initialises a time variable t to equal one. During the Kalman filter stage, this time variable is run from t=1 to N in order to process the N speech samples in the current frame being processed in time sequential order. After step s21, the processing then proceeds to step s23, where the following Kalman filter equations are computed for the current speech sample (y(t)) being processed:

w(t)=y(t)−h^{T}ŝ(t)

d(t)=h^{T}P(t)h+σ_{ε}²

k_{f}(t)=(ÃP(t)h)·d(t)⁻¹

ŝ(t+1)=Ãŝ(t)+k_{f}(t)·w(t)

L(t)=Ã−k_{f}(t)·h^{T}

P(t+1)=ÃP(t)L(t)^{T}+σₑ²·I (33)

where the initial vector of raw speech samples (ŝ(1)) includes raw speech samples obtained from the processing of the previous frame (or if there are no previous frames then s(i) is set equal to zero for i<1); P(1) is the variance of ŝ(1) (which can be obtained from the previous frame or initially can be set to σₑ²); h is the current set of channel model coefficients which can be obtained from the processing of the previous frame (or if there are no previous frames then the elements of h can be set to their expected values—zero); y(t) is the current speech sample of the current frame being processed and I is the identity matrix. The processing then proceeds to step s25 where the scalar values w(t) and d(t) are stored together with the r×r matrix L(t) (or alternatively the Kalman filter gain vector k_{f}(t) could be stored from which L(t) can be generated). The processing then proceeds to step s27 where the system determines whether or not all the speech samples in the current frame have been processed. If they have not, then the processing proceeds to step s29 where the time variable t is incremented by one so that the next sample in the current frame will be processed in the same way. Once all N samples in the current frame have been processed in this way and the corresponding values stored, the first stage of the Simulation Smoother is complete.

The processing then proceeds to step s31 where the second stage of the Simulation Smoother is started in which the smoothing filter processes the speech samples in the current frame in reverse sequential order. As shown, in step s31 the system runs the following set of smoothing filter equations on the current speech sample being processed together with the stored Kalman filter variables computed for the current speech sample being processed:

C(t)=σₑ²(I−σₑ²U(t))

η(t)˜N(0, C(t))

V(t)=σₑ²×U(t)L(t)

r(t−1)=hd(t)⁻¹w(t)+L(t)^{T}r(t)−V(t)^{T}C(t)⁻¹η(t)

U(t−1)=hd(t)⁻¹h^{T}+L(t)^{T}U(t)L(t)+V(t)^{T}C(t)⁻¹V(t)

\tilde{e}(t)=σₑ²r(t)+η(t)

where \tilde{e}(t)=[\tilde{e}(t)\tilde{e}(t−1)\tilde{e}(t−2) . . . \tilde{e}(t−r+1)]^{T}

\tilde{s}(t)=Ãŝ(t−1)+ê(t)

where ŝ(t)=[ŝ(t)ŝ(t−1)ŝ(t−2) . . . ŝ(t−r+1)]^{T}

and ê(t)=[ê(t)0 0 . . . 0]^{T}

where η(t) is a sample drawn from a Gaussian distribution having zero mean and covariance matrix C(t); the initial vector r(t=N) and the initial matrix U(t=N) are both set to zero; and s(0) is obtained from the processing of the previous frame (or if there are no previous frames can be set equal to zero). The processing then proceeds to step s33 where the estimate of the process noise (ê(t)) for the current speech sample being processed and the estimate of the raw speech sample (ŝ(t)) for the current speech sample being processed are stored. The processing then proceeds to step s35 where the system determines whether or not all the speech samples in the current frame have been processed. If they have not, then the processing proceeds to step s37 where the time variable t is decremented by one so that the previous sample in the current frame will be processed in the same way. Once all N samples in the current frame have been processed in this way and the corresponding process noise and raw speech samples have been stored, the second stage of the Simulation Smoother is complete and an estimate of s(n) will have been generated.

As shown in equations (4) and (8), the matrix S and the matrix Y require raw speech samples s(n−N−1) to s(n−N−k+1) and s(n−N−1) to s(n−N−r+1) respectively in addition to those in s(n). These additional raw speech samples can be obtained either from the processing of the previous frame of speech or if there are no previous frames, they can be set to zero. With these estimates of raw speech samples, the Gibbs sampler can be run to draw samples from the above described probability density functions.

Statistical Analysis Unit—Operation

A description has been given above of the theory underlying the statistical analysis unit 21. A description will now be given with reference to FIGS. 6 to 8 of the operation of the statistical analysis unit 21 that is used in the embodiment.

FIG. 6 is a block diagram illustrating the principal components of the statistical analysis unit 21 of this embodiment. As shown, it comprises the above described Gibbs sampler 41, Simulation Smoother 43 (including the Kalman filter 43-1 and smoothing filter 43-2) and model order selector 45. It also comprises a memory 47 which receives the speech samples of the current frame to be processed, a data analysis unit 49 which processes the data generated by the Gibbs sampler 41 and the model order selector 45 and a controller 50 which controls the operation of the statistical analysis unit 21.

As shown in FIG. 6, the memory 47 includes a non volatile memory area 47-1 and a working memory area 47-2. The non volatile memory 47-1 is used to store the joint probability density function given in equation (19) above and the equations for the variances and mean values and the equations for the Inverse Gamma parameters given above in equations (22) to (24) and (27) to (30) for the above mentioned conditional probability density functions for use by the Gibbs sampler 41. The non volatile memory 47-1 also stores the Kalman filter equations given above in equation (33) and the smoothing filter equations given above in equation 34 for use by the Simulation Smoother 43.

FIG. 7 is a schematic diagram illustrating the parameter values that are stored in the working memory area (RAM) 47-2. As shown, the RAM includes a store 51 for storing the speech samples y_{f} (1) to y_{f} (N) output by the analogue to digital converter 17 for the current frame (f) being processed. As mentioned above, these speech samples are used in both the Gibbs sampler 41 and the Simulation Smoother 43. The RAM 47-2 also includes a store 53 for storing the initial estimates of the model parameters (g=0) and the M samples (g=1 to M) of each parameter drawn from the above described conditional probability density functions by the Gibbs sampler 41 for the current frame being processed. As mentioned above, in this embodiment, M is 100 since the Gibbs sampler 41 performs 150 iterations on each frame of input speech with the first fifty samples being discarded. The RAM 47-2 also includes a store 55 for storing W(t), d(t) and L(t) for t=1 to N which are calculated during the processing of the speech samples in the current frame of speech by the above described Kalman filter 43-1. The RAM 47-2 also includes a store 57 for storing the estimates of the raw speech samples (ŝ_{f}(t)) and the estimates of the process noise (\tilde{e}_{f}(t)) generated by the smoothing filter 43-2, as discussed above. The RAM 47-2 also includes a store 59 for storing the model order counts which are generated by the model order selector 45 when the model orders for the AR filter model and the channel model are updated.

FIG. 8 is a flow diagram illustrating the control program used by the controller 50, in this embodiment, to control the processing operations of the statistical analysis unit 21. As shown, in step s41, the controller 50 retrieves the next frame of speech samples to be processed from the buffer 19 and stores them in the memory store 51. The processing then proceeds to step s43 where initial estimates for the channel model, raw speech samples and the process noise and measurement noise statistics are set and stored in the store 53. These initial estimates are either set to be the values obtained during the processing of the previous frame of speech or, where there are no previous frames of speech, are set to their expected values (which may be zero). The processing then proceeds to step s45 where the Simulation Smoother 43 is activated so as to provide an estimate of the raw speech samples in the manner described above. The processing then proceeds to step s47 where one iteration of the Gibbs sampler 41 is run in order to update the channel model, speech model and the process and measurement noise statistics using the raw speech samples obtained in step s45. These updated parameter values are then stored in the memory store 53.

The processing then proceeds to step s49 where the controller 50 determines whether or not to update the model orders of the AR filter model and the channel model. As mentioned above, in this embodiment, these model orders are updated every third Gibbs iteration. If the model orders are to be updated, then the processing proceeds to step s51 where the model order selector 45 is used to update the model orders of the AR filter model and the channel model in the manner described above. If at step s49 the controller 50 determines that the model orders are not to be updated, then the processing skips step s51 and the processing proceeds to step s53. At step s53, the controller 50 determines whether or not to perform another Gibbs iteration. If another iteration is to be performed, then the processing proceeds to decision block s55 where the controller 50 decides whether or not to update the estimates of the raw speech samples (s(t)). If the raw speech samples are not to be updated, then the processing returns to step s47 where the next Gibbs iteration is run.

As mentioned above, in this embodiment, the Simulation Smoother 43 is run every fourth Gibbs iteration in order to update the raw speech samples. Therefore, if the controller 50 determines, in step s55 that there has been four Gibbs iterations since the last time the speech samples were updated, then the processing returns to step s45 where the Simulation Smoother is run again to provide new estimates of the raw speech samples (s(t)). Once the controller 50 has determined that the required 150 Gibbs iterations have been performed, the controller 50 causes the processing to proceed to step s57 where the data analysis unit 49 analyses the model order counts generated by the model order selector 45 to determine the model orders for the AR filter model and the channel model which best represents the current frame of speech being processed. The processing then proceeds to step s59 where the data analysis unit 49 analyses the samples drawn from the conditional densities by the Gibbs sampler 41 to determine the AR filter coefficients (a), the channel model coefficients (h), the variances of these coefficients and the process and measurement noise variances which best represent the current frame of speech being processed. The processing then proceeds to step s61 where the controller 50 determines whether or not there is any further speech to be processed. If there is more speech to be processed, then processing returns to step S41 and the above process is repeated for the next frame of speech. Once all the speech has been processed in this way, the processing ends.

Data Analysis Unit

A more detailed description of the data analysis unit 49 will now be given with reference to FIG. 9. As mentioned above, the data analysis unit 49 initially determines, in step s57, the model orders for both the AR filter model and the channel model which best represents the current frame of speech being processed. It does this using the counts that have been generated by the model order selector 45 when it was run in step s51. These counts are stored in the store 59 of the RAM 47-2. In this embodiment, in determining the best model orders, the data analysis unit 49 identifies the model order having the highest count. FIG. 9a is an exemplary histogram which illustrates the distribution of counts that is generated for the model order (k) of the AR filter model. Therefore, in this example, the data analysis unit 49 would set the best model order of the AR filter model as five. The data analysis unit 49 performs a similar analysis of the counts generated for the model order (r) of the channel model to determine the best model order for the channel model.

Once the data analysis unit 49 has determined the best model orders (k and r), it then analyses the samples generated by the Gibbs sampler 41 which are stored in the store 53 of the RAM 47-2, in order to determine parameter values that are most representative of those samples. It does this by determining a histogram for each of the parameters from which it determines the most representative parameter value. To generate the histogram, the data analysis unit 49 determines the maximum and minimum sample value which was drawn by the Gibbs sampler and then divides the range of parameter values between this minimum and maximum value into a predetermined number of sub-ranges or bins. The data analysis unit 49 then assigns each of the sample values into the appropriate bins and counts how many samples are allocated to each bin. It then uses these counts to calculate a weighted average of the samples (with the weighting used for each sample depending on the count for the corresponding bin), to determine the most representative parameter value (known as the minimum mean square estimate (MMSE)). FIG. 9b illustrates an example histogram which is generated for the variance (σₑ²) of the process noise, from which the data analysis unit 49 determines that the variance representative of the sample is 0.3149.

In determining the AR filter coefficients (aᵢ for i=i to k), the data analysis unit 49 determines and analyses a histogram of the samples for each coefficient independently. FIG. 9c shows an exemplary histogram obtained for the third AR filter coefficient (a₃), from which the data analysis unit 49 determines that the coefficient representative of the samples is −0.4977.

In this embodiment, the data analysis unit 49 only outputs the AR filter coefficients which are passed to the channel encoder 71 shown in FIG. 1. The AR filter coefficients (and the remaining parameter values determined by the data analysis unit 49) are also stored in the RAM 47-2 for use during the processing of the next frame of speech.

As the skilled reader will appreciate, a speech processing technique has been described above which uses statistical analysis techniques to determine sets of AR filter coefficients representative of an input speech signal. The technique is more robust and accurate than prior art techniques which employ maximum likelihood estimators to determine the AR filter coefficients. This is because the statistical analysis of each frame uses knowledge obtained from the processing of the previous frame.

In addition, with the analysis performed above, the model order for the AR filter model is not assumed to be constant and can vary from frame to frame. In this way, the optimum number of AR filter coefficients can be used to represent the speech within each frame. As a result, the AR filter coefficients output by the statistical analysis unit 21 will more accurately represent the corresponding input speech. In contrast, with the prior art linear prediction systems, the number of AR coefficients is assumed to be constant and hence these prior art techniques tend to over parametrise the speech in order to ensure that information is not lost. As a result, with the statistical analysis described above, the amount of data which has to be transmitted from the transmitter to the receiver will be less than with the prior art systems which assume a fixed size of AR filter model.

Further still, since the underlying process model that is used separates the speech source from the channel, the AR filter coefficients that are determined will be more representative of the actual speech and will be less likely to include distortive effects of the channel.

Further still, since variance information is available for each of the parameters, this provides an indication of the confidence of each of the parameter estimates. This is in contrast to maximum likelihood and least squares approaches, such as linear prediction analysis, where point estimates of the parameter values are determined.

Alternative Embodiments

In the above embodiment, the statistical analysis unit was used in order to parameterise the input speech signal for onward transmission to a remote receiver. It also generated a number of other parameter values (such as the process noise variances and the channel model coefficients), but these were not output by the statistical analysis unit. As those skilled in the art will appreciate, the AR coefficients and some of the other parameters which are calculated by the statistical analysis unit can also be used in the transmission system. For example, the variance information of the AR coefficients can be used to control the type of channel encoding which is employed by the channel encoder 71, since this variance information is indicative of the quality of the input speech signal. For example, different channel encoding techniques may be used in dependence upon the quality of the input speech signal, with the particular technique being used depending upon the quality of the speech within each frame.

In the above embodiment, the speech generation process was modelled as an auto-regressive (AR) process and the channel was modelled as a moving average (MA) process. As those skilled in the art will appreciate, other signal models may be used. However, these models are preferred because it has been found that they suitably represent the speech source and the channel they are intended to model.

In the above embodiment, a speech quality indicator was determined for each frame of speech that is processed and the channel encoder 71 encodes each frame of speech in dependence upon the quality measure determined for each frame. As those skilled in the art will appreciate, this is not essential. For example, a moving average quality indicator may be determined and the channel encoder may be arranged to change its encoding technique when the moving average goes above or below a predetermined threshold value.

In the above embodiments, Gaussian and Inverse Gamma distributions were used to model the various prior probability density functions of equation (19). As those skilled in the art of statistical analysis will appreciate, the reason these distributions were chosen is that they are conjugate to one another. This means that each of the conditional probability density functions which are used in the Gibbs sampler will also either be Gaussian or Inverse Gamma. This therefore simplifies the task of drawing samples from the conditional probability densities. However, this is not essential. The noise probability density functions could be modelled by Laplacian or student-t distributions rather than Gaussian distributions. Similarly, the probability density functions for the variances may be modelled by a distribution other than the Inverse Gamma distribution. For example, they can be modelled by a Rayleigh distribution or some other distribution which is always positive. However, the use of probability density functions that are not conjugate will result in increased complexity in drawing samples from the conditional densities by the Gibbs sampler.

Additionally, whilst the Gibbs sampler was used to draw samples from the probability density function given in equation (19), other sampling algorithms could be used. For example the Metropolis-Hastings algorithm (which is reviewed together with other techniques in a paper entitled “Probabilistic inference using Markov chain Monte Carlo methods” by R. Neal, Technical Report CRG-TR-93-1, Department of Computer Science, University of Toronto, 1993) may be used to sample this probability density.

In the above embodiment, a Simulation Smoother was used to generate estimates for the raw speech samples. This Simulation Smoother included a Kalman filter stage and a smoothing filter stage in order to generate the estimates of the raw speech samples. In an alternative embodiment, the smoothing filter stage may be omitted, since the Kalman filter stage generates estimates of the raw speech (see equation (33)). However, these raw speech samples were ignored, since the speech samples generated by the smoothing filter are considered to be more accurate and robust. This is because the Kalman filter essentially generates a point estimate of the speech samples from the joint probability density function p(s(n)|a,k,σₑ²), whereas the Simulation Smoother draws a sample from this probability density function.

In the above embodiment, a Simulation Smoother was used in order to generate estimates of the raw speech samples. It is possible to avoid having to estimate the raw speech samples by treating them as “nuisance parameters” and integrating them out of equation (19). However, this is not preferred, since the resulting integral will have a much more complex form than the Gaussian and Inverse Gamma mixture defined in equation (19). This in turn will result in more complex conditional probabilities corresponding to equations (20) to (30). In a similar way, the other nuisance parameters (such as the coefficient variances or any of the Inverse Gamma, alpha and beta parameters) may be integrated out as well. However, again this is not preferred, since it increases the complexity of the density function to be sampled using the Gibbs sampler. The technique of integrating out nuisance parameters is well known in the field of statistical analysis and will not be described further here.

In the above embodiment, the data analysis unit analysed the samples drawn by the Gibbs sampler by determining a histogram for each of the model parameters and then determining the value of the model parameter using a weighted average of the samples drawn by the Gibbs sampler with the weighting being dependent upon the number of samples in the corresponding bin. In an alterative embodiment, the value of the model parameter may be determined from the histogram as being the value of the model parameter having the highest count. Alternatively, a predetermined curve (such as a bell curve) could be fitted to the histogram in order to identify the maximum which best fits the histogram.

In the above embodiment, the statistical analysis unit modelled the underlying speech production process with a separate speech source model (AR filter) and a channel model. Whilst this is the preferred model structure, the underlying speech production process may be modelled without the channel model. In this case, there is no need to estimate the values of the raw speech samples using a Kalman filter or the like, although this can still be done. However, such a model of the underlying speech production process is not preferred, since the speech model will inevitably represent aspects of the channel as well as the speech. Further, although the statistical analysis unit described above ran a model order selection routine in order to allow the model orders of the AR filter model and the channel model to vary, this is not essential. In particular, the model order of the AR filter model and the channel model may be fixed in advance, although this is not preferred since it will inevitably introduce errors into the representation.

In the above embodiments, the speech that was processed was received from a user via a microphone. As those skilled in the art will appreciate, the speech may be received from a telephone line or may have been stored on a recording medium. In this case, the channel model will compensate for this so that the AR filter coefficients representative of the actual speech that has been spoken should not be significantly affected.

In the above embodiments, during the running of the model order selection routine, a new model order was proposed by drawing a random variable from a predetermined Laplacian distribution function. As those skilled in the art will appreciate, other techniques may be used. For example the new model order may be proposed in a deterministic way (ie under predetermined rules), provided that the model order space is sufficiently sampled.

1. An audio encoding system comprising:
a memory for storing a predetermined function which gives, for a given set of audio signal values, a probability density for parameters of a predetermined audio model which is assumed to have generated the set of audio signal values, the probability density defining, for a given set of model parameter values, the probability that the predetermined audio model has those parameter values, given that the model is assumed to have generated the set of audio signal values;
means for receiving a set of audio signal values representative of an input audio signal;
means for applying the set of received audio signal values to said stored function to give the probability density for said model parameters for the set of received audio signal values;
means for processing said function with said set of received audio signal values applied, to derive samples of parameter values from said probability density;
means for analysing at least some of said derived samples of parameter values to determine parameter values that are representative of the set of received audio signal values; and
means for encoding said determined parameter values to generate encoded data representative of the received audio signal values.

2. A system according to claim 1, wherein said processing means is operable to draw samples iteratively from said probability density function.

3. A system according to claim 2, wherein said processing means comprises a Gibbs sampler.

4. A system according to claim 2, wherein said analysing means is operable to determine a histogram of said drawn samples and wherein said values of said parameters are determined from said histogram.

5. A system according to claim 4, wherein said processing means is operable to determine said values of said first parameters using a weighted sum of said drawn samples and wherein the weighting for each sample is determined from said histogram.

6. A system according to claim 1, wherein said receiving means is operable to receive a sequence of sets of signal values representative of an input audio signal and wherein said applying means, processing means and analysing means are operable to perform their function with respect to each set of received audio signal values to determine parameter values that are representative of each set of received audio signal values.

7. A system according to claim 6, wherein said processing means is operable to use the values of parameters obtained during the processing of a preceding set of signal values as initial estimates for the values of the corresponding parameters for a current set of signal values being processed.

8. A system according to claim 6, wherein said sets of signal values in said sequence are non-overlapping.

9. A system according to claim 6, wherein said processing means comprises means for varying the number of parameters used to represent the audio signal within each set of audio signal values.

10. A system according to claim 1, wherein said audio model comprises an auto-regressive process model and wherein said parameters include auto-regressive model coefficients.

11. A system according to claim 1, wherein said received set of audio signal values are representative of an input speech signal.

12. A system according to claim 11, wherein said received set of speech signal values are representative of a speech signal generated by a speech source as distorted by a transmission channel between the speech source and the receiving means; wherein said predetermined function includes a first part having first parameters which models said source and a second part having second parameters which models said channel; wherein said processing means is operable to derive samples of at least said first parameters; and wherein said analysing means is operable to determine values of said first parameters that are representative of said speech generated by said speech source before it was distorted by said transmission channel.

13. A system according to claim 12, wherein said function is in terms of a set of raw speech signal values representative of speech generated by said source before being distorted by said transmission channel, wherein the system further comprises second processing means for processing the received set of signal values with initial estimates of said first and second parameters, to generate an estimate of the raw speech signal values corresponding to the received set of signal values and wherein said applying means is operable to apply said estimated set of raw speech signal values to said function in addition to said set of received signal values.

14. A system according to claim 13, wherein said second processing means comprises a simulation smoother.

15. A system according to claim 13, wherein said second processing means comprises a Kalman filter.

16. A system according to claim 12, wherein said second part is a moving average model and said second parameters comprise moving average model coefficients.

17. A system according to claim 1, further comprising means for evaluating said probability density function for the set of received signal values using one or more of said drawn samples of parameter values for different numbers of parameter values, to determine respective probabilities that the predetermined signal model has those parameter values and wherein said processing means is operable to process at least some of said drawn samples of parameter values and said evaluated probabilities to determine said values of said parameters that are representative of the received audio signal.

18. A system according to claim 1, wherein said analysing means is operable to analyse at least some of said derived samples of parameter values to determine a measure of the variance of at least some of said samples of parameter values; wherein said system further comprises means for determining an indication of the quality of the received audio signal using said variance measure; and wherein said encoding means is operable to encode said determined parameter values in dependence upon the determined quality indication.

19. A system according to claim 18, wherein said encoding means is operable to encode said parameter values using a first encoding technique if said quality indication is above a predetermined value and is operable to encode said parameter values using a second encoding technique if said quality indication is below said value.

20. A system according to claim 19, wherein said first encoding technique is operable to minimise the data to be transmitted and wherein said second encoding technique is operable to minimise information lost in the encoding.

21. An audio transmission system comprising:
a transmission unit comprising: means for receiving an audio signal; an audio encoding system according to claim 1 for generating encoded parameter values representative of received audio signal values; and means for transmitting the encoded parameter values; and a receiver unit comprising means for receiving the transmitted parameter values; and means for processing the received parameter values to generate an output signal in dependence thereon.

22. A system according to claim 21, wherein said processing means of said receiving unit comprises speech synthesis means for generating a synthesised speech signal in dependence upon the received parameter values.

23. A system according to claim 21, wherein said processing means of said receiving unit comprises a speech recognition system which operable to compare the received parameter values with stored reference models to generate a recognition result.

24. A system according to claim 21, wherein said transmission unit is operable to transmit said quality indication to said receiving unit and wherein said receiving unit is operable to receive said quality indication and to decode said encoded parameters in dependence upon the received quality indication.

25. A system according to claim 24, wherein said receiving unit is operable to decode said encoded parameter values in accordance with a first decoding technique if said quality indication has a value above a predetermined threshold value and is operable to decode said encoded parameter values in accordance with a second decoding technique if said quality indication is below said predetermined value.

26. An audio transmission system comprising a transmitter and receiver, wherein
the transmitter comprises:
means for receiving an input audio signal;
means for determining a measure of the quality of the input audio signal;
means for encoding data representative of the audio signal in dependence upon the determined quality measure; and
means for transmitting the encoded audio data; and wherein
said receiver comprises:
means for receiving the encoded audio data;
means for decoding the transmitted audio data; and
means for outputting the decoded audio data.

27. A system according to claim 26, wherein said transmitter is operable to transmit said quality measure and wherein said decoder is operable to decode said encoded audio data in dependence upon the received quality measure.

28. A system according to claim 26, wherein said encoder is operable to encode said audio signal in accordance with a first encoding technique if said quality measure is above a predetermined threshold and is operable to encode said audio signal in accordance with a second encoding technique if said quality measure is below a predetermined threshold.

29. A system according to claim 28, wherein said first encoding technique is operable to minimise the data to be transmitted and where said second encoding technique is operable to minimise information lost in the encoding.

30. An audio transmission system comprising a transmission unit and a receiving unit, wherein
the transmission unit comprises:
a memory for storing a predetermined function which gives, for a given set of audio signal values, a probability density for parameters of a predetermined audio model which is assumed to have generated the set of audio signal values, the probability density defining, for a given set of model parameter values, the probability that the predetermined audio model has those parameter values, given that the model is assumed to have generated the set of audio signal values;
means for receiving a set of audio signal values representative of an input audio signal;
means for applying the set of received audio signal values to said stored function to give the probability density for said model parameters for the set of received audio signal values;
means for processing said function with said set of received audio signal values applied, to derive samples of parameter values from said probability density;
means for analysing at least some of said derived samples of parameter values to determine parameter values that are representative of the set of received audio signal values; and
means for transmitting said determined parameter values; and wherein
the receiver unit comprises:
means for receiving said transmitted parameter values; and
means for processing the received parameter values to generate an output signal in dependence thereon.

31. A system according to claim 30, wherein said transmission unit further comprises means for encoding the determined parameter values and wherein said receiving unit comprises means for decoding the encoded parameter values.

32. A transmitter apparatus comprising:
a memory for storing a predetermined function which gives, for a given set of audio signal values, a probability density for parameters of a predetermined audio model which is assumed to have generated the set of audio signal values, the probability density defining, for a given set of model parameter values, the probability that the predetermined audio model has those parameter values, given that the model is assumed to have generated the set of audio signal values;
means for receiving a set of audio signal values representative of an input audio signal;
means for applying the set of received audio signal values to said stored function to give the probability density for said model parameters for the set of received audio signal values;
means for processing said function with said set of received audio signal values applied, to derive samples of parameter values from said probability density;
means for analysing at least some of said derived samples of parameter values to determine parameter values that are representative of the set of received audio signal values; and
means for transmitting said determined parameter values.

33. A transmitter apparatus comprising:
means for receiving an input audio signal;
means for determining a measure of the quality of the input audio signal;
means for encoding data representative of the audio signal in dependence upon the determined quality measure; and
means for transmitting the encoded data.

34. A transmitter according to claim 33, wherein said transmitting means is operable to transmit said quality measure in addition to said encoded data.

35. A transmitter according to claim 33, wherein said encoder is operable to encode said audio signal in accordance with a first encoding technique if said quality measure is above a predetermined threshold and is operable to encode said audio signal in accordance with a second encoding technique if said quality measure is below a predetermined threshold.

36. A transmitter according to claim 35, wherein said first encoding technique is operable to minimise the data to be transmitted and wherein said second encoding technique is operable to minimise information lost in the encoding.

37. An audio encoding method comprising the steps of:
storing a predetermined function which gives, for a given set of audio signal values, a probability density for parameters of a predetermined audio model which is assumed to have generated the set of audio signal values, the probability density defining, for a given set of model parameter values, the probability that the predetermined audio model has those parameter values, given that the model is assumed to have generated the set of audio signal values;
receiving a set of audio signal values representative of an input audio signal at a receiver;
applying the set of received audio signal values to said stored function to give the probability density for said model parameters for the set of received audio signal values;
processing said function with said set of received audio signal values applied, to derive samples of parameter values from said probability density;
analysing at least some of said derived samples of parameter values to determine parameter values that are representative of the set of received audio signal values; and
encoding said determined parameter values to generate encoded data representative of the received audio signal values.

38. A method according to claim 37, wherein said processing step draws samples iteratively from said probability density function.

39. A method according to claim 38, wherein said processing step uses a Gibbs sampler.

40. A method according to claim 38, wherein said analysing step determines a histogram of said drawn samples and wherein said values of said parameters are determined from said histogram.

41. A method according to claim 40, wherein said processing step determines said values of said first parameters using a weighted sum of said drawn samples and wherein the weighting for each sample is determined from said histogram.

42. A method according to any of claim 37, wherein said receiving step receives a sequence of sets of signal values representative of an input audio signal and wherein said applying step, processing step and analysing step are performed for each set of received audio signal values to determine parameter values that are representative of each set of received audio signal values.

43. A method according to claim 42, wherein said processing step uses the values of parameters obtained during the processing of a preceding set of signal values as initial estimates for the values of the corresponding parameters for a current set of signal values being processed.

44. A method according to claim 42, wherein said sets of signal values in said sequence are non-overlapping.

45. A method according to claim 42, wherein said processing step comprises the step of varying the number of parameters used to represent the audio signal within each set of audio signal values.

46. A method according to claim 37, wherein said audio model comprises an auto-regressive process model and wherein said parameters include auto-regressive model coefficients.

47. A method according to claim 37, wherein said received set of audio signal values are representative of an input speech signal.

48. A method according to claim 47, wherein said received set of speech signal values are representative of a speech signal generated by a speech source as distorted by a transmission channel between the speech source and the receiver; wherein said predetermined function includes a first part having first parameters which models said source and a second part having second parameters which models said channel; wherein said processing step derives samples of at least said first parameters; and wherein said analysing step determines values of said first parameters that are representative of said speech generated by said speech source before it was distorted by said transmission channel.

49. A method according to claim 48, wherein said function is in terms of a set of raw speech signal values representative of speech generated by said source before being distorted by said transmission channel, further comprising a second processing step for processing the received set of signal values with initial estimates of said first and second parameters, to generate an estimate of the raw speech signal values corresponding to the received set of signal values and wherein said applying step applies said estimated set of raw speech signal values to said function in addition to said set of received signal values.

50. A method according to claim 49, wherein said second processing step uses a simulation smoother.

51. A method according to claim 49, wherein said second processing step uses a Kalman filter.

52. A method according to claim 48, wherein said second part is a moving average model and said second parameters comprise moving average model coefficients.

53. A method according to claim 37, further comprising the step of evaluating said probability density function for the set of received signal values using one or more of said drawn samples of parameter values for different numbers of parameter values, to determine respective probabilities that the predetermined signal model has those parameter values and wherein said processing step processes at least some of said drawn samples of parameter values and said evaluated probabilities to determine said values of said parameters that are representative of the received audio signal.

54. A method according to claim 37, wherein said analysing step analyses at least some of said derived samples of parameter values to determine a measure of the variance of at least some of said samples of parameter values; further comprising the step of determining an indication of the quality of the received audio signal; and wherein said encoding step encodes said determined parameter values in dependence upon the determined quality indication.

55. A method according to claim 54, wherein said encoding step encodes said parameter values using a first encoding technique if said quality indication is above a predetermined value and encodes said parameter values using a second encoding technique if said quality indication is below said value.

56. A method according to claim 55, wherein said first encoding technique is operable to minimise the data to be transmitted and wherein said second encoding technique is operable to minimise information lost in the encoding.

57. An audio transmission method comprising the steps of:
receiving an audio signal at a transmission unit;
encoding the audio signal using a method according to claim 37 to generate encoded parameter values representative of the audio signal; and
transmitting the encoded parameters values;
receiving the transmitted encoded parameter values at a receiver unit;
decoding the received encoded parameter values;
processing the decoded parameter values to generate and output signal in dependence thereon.

58. A method according to claim 37, wherein said processing step at said receiving unit comprises speech synthesis means for generating a synthesised speech signal in dependence upon the received parameter values.

59. A method according to claim 37, wherein said processing step at said receiving unit uses a speech recognition system to compare the received parameter values with stored reference models and to generate a recognition result.

60. A method according to claim 57, further comprising the step of transmitting said quality indication to said receiving unit and, at said receiving unit, the steps of receiving said quality indication and decoding said encoded parameters in dependence upon the received quality indication.

61. A method according to claim 60, comprising the step of, at said receiving unit, decoding said encoded parameter values in accordance with a first decoding technique if said quality indication has a value above a predetermined threshold value and decoding said encoded parameter values in accordance with a second decoding technique if said quality indication is below said predetermined value.

62. An audio transmission method using a transmitter and receiver, the method comprising the steps of:
at the transmitter:
receiving an audio signal;
determining a measure of the quality of the received audio signal;
encoding data representative of the audio signal in dependence upon the determined quality measure; and
transmitting the encoded data; and
at said receiver:
receiving the encoded audio data;
decoding the transmitted audio data; and
outputting the decoded audio data.

63. A method according to claim 62, further comprising the step of, at said transmitter, transmitting said quality measure and wherein said decoding step decodes said encoded audio data in dependence upon the received quality measure.

64. A method according to claim 61, wherein said encoding step encodes said audio signal in accordance with a first encoding technique if said quality measure is above a predetermined threshold and encodes said audio signal in accordance with a second encoding technique if said quality measure is below a predetermined threshold.

65. A method according to claim 63, wherein said first encoding technique is operable to minimise the data to be transmitted and where said second encoding technique is operable to minimise information lost in the encoding.

66. An audio transmission method using a transmission unit and a receiving unit, wherein the method comprises the steps of:
at the transmission unit:
storing a predetermined function which gives, for a given set of audio signal values, a probability density for parameters of a predetermined audio model which is assumed to have generated the set of audio signal values, the probability density defining, for a given set of model parameter values, the probability that the predetermined audio model has those parameter values, given that the model is assumed to have generated the set of audio signal values;
receiving a set of audio signal values representative of an input audio signal;
applying the set of received audio signal values to said stored function to give the probability density for said model parameters for the set of received audio signal values;
processing said function with said set of received audio signal values applied, to derive samples of parameter values from said probability density;
analysing at least some of said derived samples of parameter values to determine parameter values that are representative of the set of received audio signal values; and
transmitting said determined parameter values; and
at the receiver unit:
receiving said transmitted parameter values; and
processing the received parameter values to generate an output signal in dependence thereon.

67. A computer readable medium storing computer executable process steps to cause a programmable computer apparatus to perform the method of claim 37.

68. Processor implementable process steps for causing a programmable computing device to perform the method according to claim 37.
